(19) United States
(12) Patent Application Publication
(10) Pub. No.: US 2004/0244703 A1
(43) Pub. Date: Dec. 9, 2004

(54) Ant resistant dish and tray

(76) Inventor: Michael Lehman, Del Mar, CA (US)

Correspondence Address: Steven W. Webb, Law Offices of Steven W. Webb, 655 2nd Street, Encinitas, CA, 92024, US

(21) Appl. No.: 10/840,119

(22) Filed: May 6, 2004

Related U.S. Application Data
(60) Provisional application No. 60/467,919, filed on May 6, 2003.

(51) Int. Cl. A01K 5/01

(52) U.S. Cl. 119/61.53; 119/61.5

(57) ABSTRACT

A new kind of insect-resistant food container is presented which uses physical means including a sticky polymer to trap insects and prevent them from reaching the food. The typical implementation of this invention is a bowl on a pedestal with a sticky polymer trap under the bowl rim, where it cannot be seen.

### RELATED U.S. APPLICATIONS

This application supplements and completes Provisional Application 60/467,919, filed May 6, 2003.

### BACKGROUND OF THE INVENTION

This invention relates to food service devices that prevent invasion by insects, particularly those intended for use outdoors. This invention is particularly related to insect-resistant pet food dishes.

### BRIEF SUMMARY OF THE INVENTION

This invention is designed to substitute for a regular food service dish or tray, but be resistant to invasion by crawling insects, particularly ants. The main mode of this invention is a pet food dish, a “doggie dish”, that has a uniquely treated sticky polymer placed strategically on the underside. Insects crawling up the side of the dish pedestal will encounter this substance and be held and killed. An off-the-shelf organic compound can be added to the sticky polymer as an insect repellant. In most cases, this device will serve as a support plate for a regular food plate.

The invention is designed to be detachable into three main components for easy washing and sticky polymer replacement. The pedestal can be made in various widths to provide support and prevent tipping over in case a large animal is using the dish. Water bowls and food bowls can be fitted on top of this device.

A secondary mode of this invention is a food service tray that possesses a layer of the uniquely treated sticky polymer between its support member and the serving surface of the tray. This tray will permit picnic food to be left out in an unsealed container without worrying about ant infestation. The tray is also designed to be easily washable and permitting replacement of the sticky polymer.

### BRIEF DESCRIPTION OF THE DRAWINGS

The construction and operation of the invention can be readily appreciated from inspection of the drawings that accompany this application.

FIG. 1 is a perspective view of the pet dish.

FIG. 2 is a cross-section view of the pet dish.

FIG. 3 is a top view of the food tray.

FIG. 4 is a cross-section view of the food tray.

FIG. 5 is a bottom view of the food tray.

### DETAILED DESCRIPTION OF THE INVENTION

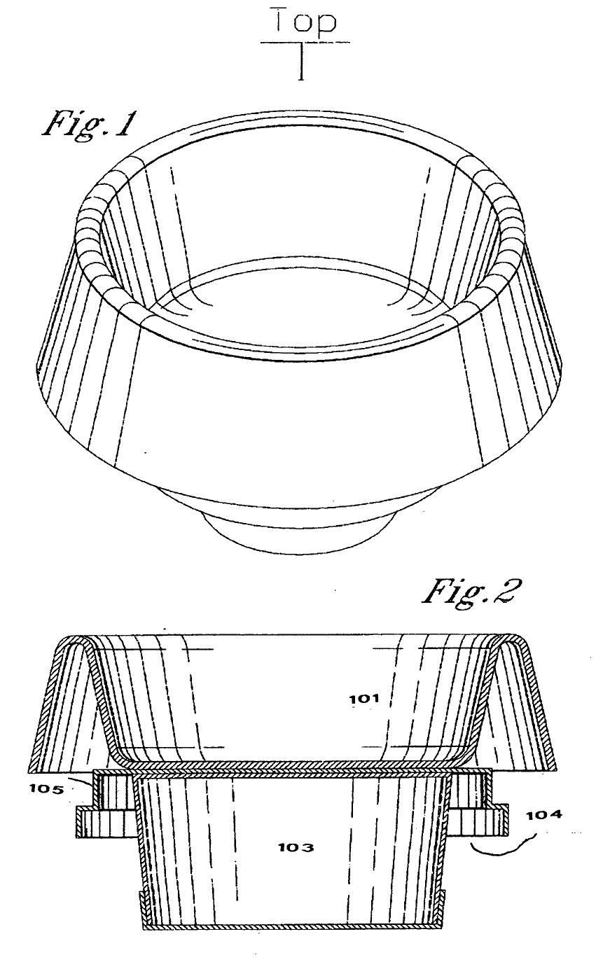

As in FIG. 1 and FIG. 2, the pet dish 100 consists of a bowl 101, pedestal 103, bottom flange 104 and uniquely treated sticky polymer 105. The pedestal 103 is cylindrical and optionally of various diameters. The bottom flange 104 is a concave, cylindrical inverted bowl that is lined with the uniquely treated sticky polymer 105. The bowl 101, barrier 104, and pedestal 103 are optionally detachable from each other to make for easier cleaning and replacement of the sticky polymer 105. The invention is made entirely from rigid plastic material in the preferred embodiment.

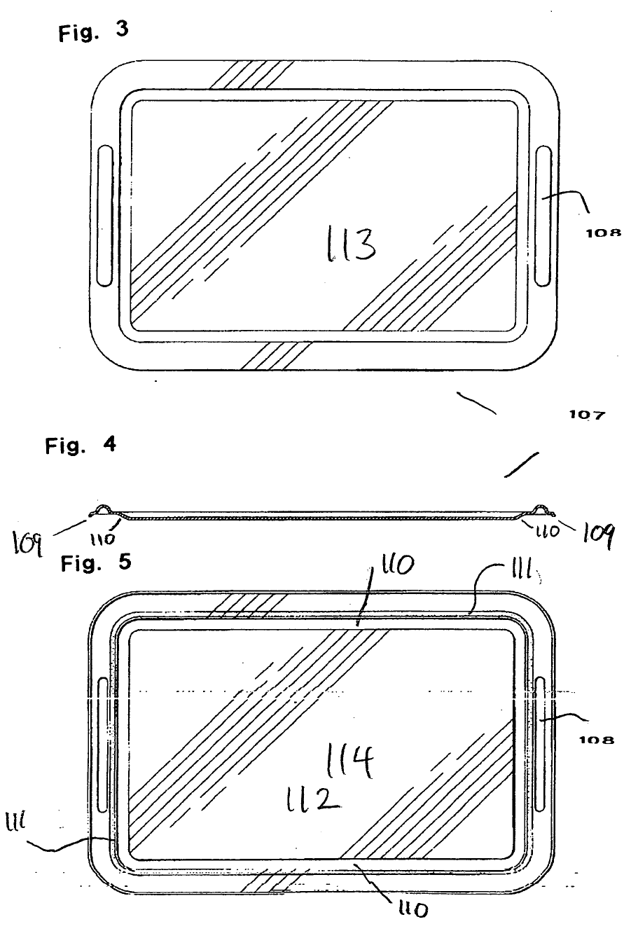

Another embodiment of the invention, shown in FIGS. 3, 4, and 5 is a tray 107 with handles 108, an upper surface 113 and a concave lower surface. The lower surface 114, in FIG. 5, consists of a tray edge 109, a tray rim 110, a recess 111, and tray underside 112. The tray rim 110 extends out from the flat lower surface 114 and should not contact any surface on which the tray will rest.

Outside the tray rim 110 is a recess 111 where the uniquely treated sticky polymer will be placed. The recess 111 is between the rim 110 and the top surface of the tray 113 so that any crawling insects, such as ants, would have to contact the uniquely treated sticky polymer before they can reach the upper surface 113. This is the preferred embodiment of this tray invention.

Other embodiments including taller rims and different shapes for the tray (circular, diamond-shaped, etc.) are possible. The dish and the tray are related inventions and are close derivatives of each other in that they use a combination of a physical barrier and a uniquely treated sticky polymer to prevent crawling insect infestation.

What is claimed is:

1. An ant-resistant food container that provides a physical barrier and a sticky polymer ant-trap between any surface upon which the ant-resistant food container rests and food in the ant-resistant food container,
the ant-resistant food container comprised of a food surface support, a surrounding ant barrier, and a food surface,
the food surface support possessing a lower surface that rests evenly on a flat surface, the food surface support rising from the flat surface and connected to the surrounding ant barrier,
the surrounding ant barrier completely encircling the food service support such that the any insect climbing from the food surface support lower surface up the side of the food surface support must walk across the surrounding ant barrier on its way to the food surface,
the surrounding ant barrier comprised of a physical barrier and a sticky polymer trap,
the sticky polymer trap comprised of any semi-strong adhesive that can hold a typical crawling insect that encounters it, the sticky polymer trap using no insecticides, man-made or natural,
the food surface capable of holding food while the upper surface is supported by the food surface support.

2. The ant-resistant food container of claim 1, where the food surface is a bowl, the bowl possessing a circular rim, the food surface support is a pedestal, the surrounding ant barrier is a circumferential recess under the rim of the bowl, and the bowl, pedestal, and surrounding ant barrier are detachable from each other for washing.

3. The ant-resistant food container of claim 1 where the food surface is a tray, the tray is flat with a raised rim, the food surface support is the underside of the tray, and the surrounding ant barrier is a recess under the raised rim of the tray containing the sticky polymer trap.
